(19) United States
(12) Patent Application Publication
(10) Pub. No.: US 2013/0280383 A1
(43) Pub. Date: Oct. 24, 2013

(54) Electrolyte Fortifying Composition for Recharge, a Hydrating Supplement, and Process for Preparing the Same

(71) Applicants: Pradeep Poddar, Mumbai (IN); Henry Hidell, Hingham, MA (US); C.E. Agro, Oakville (CA); Micheal Collete, Oakville (CA)

(72) Inventors: Pradeep Poddar, Mumbai (IN); Henry Hidell, Hingham, MA (US); C.E. Agro, Oakville (CA); Micheal Collete, Oakville (CA)

(73) Assignee: Tata Global Beverages Limited, Kolkata (IN)

(21) Appl. No.: 13/825,785

(22) PCT Filed: Sep. 23, 2011
(86) PCT No.: PCT/IN11/00674

§ 371 Date: Jul. 9, 2013

(30) Foreign Application Priority Data
Sep. 23, 2010 (IN) 1070/KOL/2010

(51) Int. Cl. A23L 2/52; A23L 1/304

(52) U.S. Cl. CPC A23L 2/52; A23L 1/304
USPC 426/66; 426/74

(57) ABSTRACT

Nutrient fortifying composition for food products and electrolyte fortifying composition for recharge comprising calcium chloride, magnesium chloride, potassium bicarbonate, acidity regulator, copper sulphate; and class II preservative. A hydration supplement and a fortified water beverage to supplement the deficiencies of chromium and boron in humans. The hydrating supplement is such that the amount of the calcium chloride is 9.5% to 15.695% by weight, amount of Magnesium chloride is 2.2% to 10.31% by weight, amount of potassium bicarbonate is 10.2% to 15.99% by weight and amount of Copper sulfate is 32.14% to 55.7% by weight. The hydrating supplement is in liquid or semi I solid form, such as a beverage such as aerated drink or treated water.

### FIELD OF INVENTION

Present invention provides electrolyte fortifying composition, a hydrating supplement and the process for preparing the same for recharging the body with required salt. More particularly the invention provides electrolyte fortified beverages.

### BACKGROUND OF THE INVENTION

Micronutrients are nutrients needed throughout life in small quantities. They are dietary nutrients needed by the human body in very small quantities (generally less than 100 micrograms/day) as opposed to macro-nutrients which are required in larger quantities. The micro-nutrients or trace elements include at least iron, cobalt, chromium, copper, iodine, manganese, selenium, zinc, boron and molybdenum.

Due to urbanization, over population and ill practices of agriculture there are losses of essential minerals from the soil. Due to insufficient nutrients in soil there is a declination of nutrients in food, which in turn causes deficiency of nutrients among the subjects who consume such food. Some major consequences are of such deficiencies are bone disease, in every age group.

The water in the body contains dissolved minerals called electrolytes. They include sodium, potassium, and calcium. The body must also keep levels of electrolytes in balance and relatively constant. The balance of electrolytes is closely tied to the balance of water in the body: If one changes, the other usually also changes.

In particular, the maintenance of precise osmotic gradients of electrolytes is important. Such gradients affect and regulate the hydration of the body as well as blood pH, and are critical for nerve and muscle function. Various mechanisms exist in living species that keep the concentrations of different electrolytes under tight control.

Both muscle tissue and neurons are considered electric tissues of the body. Muscles and neurons are activated by electrolyte activity between the extracellular fluid or interstitial fluid, and intracellular fluid. Electrolytes may enter or leave the cell membrane through specialized protein structures embedded in the plasma membrane called ion channels. For example, muscle contraction is dependent upon the presence of calcium (Ca²⁺), sodium (Na⁺), and potassium (K⁺). Without sufficient levels of these key electrolytes, muscle weakness or severe muscle contractions may occur.

Electrolyte balance is maintained by oral, or in emergencies, intravenous (IV) intake of electrolyte-containing substances, and is regulated by hormones, generally with the kidneys flushing out excess levels. In humans, electrolyte homeostasis is regulated by hormones such as antidiuretic hormone, aldosterone and parathyroid hormone. Serious electrolyte disturbances, such as dehydration and overhydration, may lead to cardiac and neurological complications and, unless they are rapidly resolved, will result in a medical emergency.

In oral rehydration therapy, electrolyte drinks containing sodium and potassium salts replenish the body's water and electrolyte levels after dehydration caused by exercise, diaphoresis, diarrhea, vomiting, intoxication or starvation. Athletes exercising in extreme conditions (for three or more hours continuously e.g. marathon or triathlon) who do not consume electrolytes risk dehydration (or hyponatremia).

A simple electrolyte drink can be home-made by using the correct proportions of water, sugar, salt, salt substitute for potassium, and baking soda. However, effective electrolyte replacements should include all electrolytes required by the body, including sodium chloride, potassium, magnesium, and calcium that can be either obtained in a sports drink or a solid electrolyte capsule.

Several food and beverages have been provided to supplement the deficiencies of the electrolyte in the human bodies.

Therefore, the object of the present invention is to provide a composition of required salts for fortifying food for human consumption.

Therefore, the object of the present invention is to provide a composition of electrolytes for fortifying food for recharging the human body.

Further, the object of the present invention is to provide a hydrating supplement fortified with the electrolytes to supplement the deficiencies of electrolytes and salts in humans.

Further, the object of the present invention is to provide treated water beverage fortified with the electrolytes to supplement the deficiencies of salts in humans.

Further, object of the present invention is to provide the process for the preparation of the composition of electrolytes.

Further, object of the present invention is to provide the process for the preparation of the treated water beverage fortified with the electrolytes to supplement the deficiencies.

### SUMMARY OF THE INVENTION

In order to obviate the drawbacks of the prior art and to provide a suitable supplement nutrients, the present invention provides a supplement of salts which act as electrolyte in the human bodies.

The present invention provides—electrolyte composition of salts and micronutrients fortifying for the food products for recharging the human. Said—electrolytes composition comprises:
Calcium Chloride;
Magnesium Chloride;
Potassium Bicarbonate;
Acidity regulator (330);
Copper Ion Source; and
Class II preservative (202).

The percentage of amount of the ingredients in the composition is as follows:
Calcium Chloride, at least 9.76% by wt;
Magnesium Chloride, at least 2.29% by wt;
Potassium Bicarbonate, at least 10.69% by wt;
Acidity regulator (330), at least 22.65% by wt;
Copper Ion Source 54.70%, at least by wt; and
Class II preservative (202) 0.01% by wt.

The invention further provides a hydration supplement for human consumption. Said hydration supplement comprising the electrolyte composition along with suitable food or water beverage item. The amount of composition in the hydrating supplement is such that the amount of the calcium chloride is 9.5% to 15.695% by weight, amount of Magnesium chloride is 2.2% to 10.31% by weight, amount of potassium bicarbonate is 10.2% to 15.99% by weight and amount of Copper sulfate is 32.14% to 55.7% by weight.

Said hydrating supplement is in liquid or semi/solid form. Further said hydrating supplement may be a beverage such as aerated drink, treated water, etc.

Further, the Copper from the Copper source in the composition enables cold-filling process of packaging. The filling could then be carried out without the presence of ozone in the product and also obviating the necessity of hot-fill process thereby enhancing the efficacy of the electrolytes from the Recharge composition.

The invention further provides treated water fortified with electrolyte composition for use as beverages.

The treated water beverage comprises:
treated water prepared by the process taught in our co-pending application,
Electrolyte composition comprising Calcium Chloride, Magnesium Chloride, Potassium Bicarbonate, acidity regulator (330), Copper Ion Source, class II preservative (202)

Said composition comprises essential electrolytes, providing electrolytes Calcium Chloride (at least 3.8 mg per litre), Magnesium Chloride (at least 0.9 mg per litre), Potassium Bicarbonate (at least 4.2 mg per litre) and Copper from Copper Ion Source providing (0.8 to 1.2 mg of Cu) Potassium Sorbate (0.01% by weight) of the Recharge hydration supplement.

An important feature of the present invention is that the treated water beverage has no added flavors or sweeteners to mask ingredient flavors and is water neutral.

The ingredients used in the water neutral beverage are selected in a manner as to be compatible with water such that they do not have any odour, the composition does not precipitate or reacts or sediments. Also, the shelf life of the elements has been so maintained in the composition that when the composition does not degrade when used with water. Said effects are the result of the synergistic effect among the ingredients of the composition.

The invention further provides the process for the preparation of the beverage fortified with electrolytes composition taught above.

The treated water used in the preparation of the beverage of the present invention is prepared by the process provide in the co-pending application.

### DETAILED DESCRIPTION OF THE INVENTION

It has been found that there are several benefits of adding a modest amount of electrolytes such as magnesium as magnesium chloride, calcium as calcium chloride and potassium as potassium bicarbonate to the beverages and food items. The present invention has been especially has been made keeping in view the large masses of population suffering from various deficiency diseases such as cardiovascular diseases, arthritis, anemia, diabetes etc. The amount added is at least 23 μg of elemental magnesium, at least 137 μg of elemental calcium, at least 164 μg of elemental potassium and at least 0.08 mg of elemental copper per 100 ml of water. Further, motive of the present invention is to provide both an inexpensive sources for safe drinking water and additional dietary nutrients for nutrient deficit populations.

### Functions of Magnesium in Human Body

Magnesium is an essential intracellular cation. Nearly 99% of the total body Mg is located in bone or the intracellular space. It is a critical cation and cofactor in numerous intracellular processes. Intracellular Mg is correlated with intracellular potassium. In humans, Mg appears to facilitate calcium absorption. It acts as:
a cofactor for adenosine triphosphate (ATP); an important membrane stabilizing agent
providing structural integrity of numerous intracellular proteins and nucleic acids
a substrate or cofactor for important enzymes such as adenosine triphosphatase, guanosine triphosphatase, phospholipase C, adenylate cyclase, and guanylate cyclase
a required cofactor for the activity of over 300 other enzymes
a regulator of ion channels
an important intracellular signaling molecule
a modulator of oxidative phosphorylation
controls the fate of potassium (K) & calcium (Ca) in the body

### How Much Magnesium is Required in Humans?

The current reference intake values for magnesium as described in the DRI's established by the United States Institute Of Medicine (IOM 1997) are as follows.

TABLE 1
DRI values for Magnesium (from IOM 1997)

| | | Magnesium intake (mg/day) | | |
|---|---|---|---|---|
| Group | | AI | EAR | RDA |
| 0 to 6 | months | 30 | — | — |
| 7 to 12 | months | 75 | — | — |
| 1-3 | years | — | 65 | 80 |
| 4-8 | years | — | 110 | 130 |
| 9-13 | years | — | 200 | 240 |
| 14-18 | years | — | 340/300^{a} | 410/360^{a} |
| 19-50 | years | — | 330/255^{a} | 400/310^{a} |
| 50+ | years | — | 350/265^{a} | 400/310^{a} |

Pregnancy

| | | | | |
|---|---|---|---|---|
| <18 | years | — | 335 | 400 |
| 19-30 | years | — | 290 | 350 |
| 31-50 | years | — | 300 | 360 |

Lactation

| | | | | |
|---|---|---|---|---|
| <18 | years | — | 300 | 360 |
| 19-30 | years | — | 255 | 310 |
| 31-50 | years | — | 265 | 320 |

^{a}Male/Female

### Intakes in the United States & Canada

The 2005 Dietary Guidelines for Americans (United States Department of Agriculture and United States Department of Health and Human Services 2005) reported that less than 60% of adult men and women in the United States met the AI values for magnesium.

TABLE 2
Reported ranges for magnesium intakes by adults in
countries other than the United States

| Country/Area | Magnesium intake (mg/day) |
|---|---|
| Canada | 209-279 |
| France | 284-377 |
| Guam | 270 ± 131 |
| Indonesia | Not determined |
| Israel | 228-270 |
| Japan | Not determined |
| Malaysia | Not determined |
| Myanmar | Not determined |
| Pakistan | Not determined |
| Philippines | Not determined |
| Singapore | Not determined |
| South Africa | 228-285 |
| Spain | 366 |
| United Kingdom | Not determined |
| Vietnam | Not determined |
| Adult DRI | 255-265 female (EAR) |
| | 330-350 male (EAR) |

^{a}Sources: Monge-Rojas 2001; Galan et al. 2002; Troppmann et al. 2002; Jodral-Segado et al. 2003; Pobocik et al. 2003; Akhter et al. 2004; Nakamura et al. 2004; Charlton et al. 2005; Reimer et al. 2005; Shahar et al. 2005; Tee and Florentino 2005.

### Dietary Sources of Magnesium

Most dark green leafy vegetables such as Spinach, Kale, Broccoli, Avocado; legume seeds, peas, beans, and nuts are rich in magnesium, as are some shellfish, spices, and soya flour, all of which usually contain more than 500-mg/kg fresh weight. Although most unrefined cereal grains are reasonable sources, many highly refined flours, tubers, fruits, fungi and most oils and fats contribute little dietary magnesium (<100-mg/kg fresh weight).

### Interest in Magnesium Fortified Products

Along with the current developments of the overall functional food markets, the use of electrolytes especially magnesium chloride is expected to exhibit strong growth rates. Future trends include growing consumer concern regarding cardiovascular diseases, leading to increased sales of magnesium salts. Deficiency of magnesium causes many chronic diseases such as cardiovascular disease, arthritis, stroke, alzheimer disease, sudden infant death syndrome and many more.

### Magnesium Chloride

Magnesium chloride is an essential electrolyte needed for proper growth of body. It is a salt that is highly soluble in water. It is an important component in the polymerase chain reaction, a procedure used to amplify DNA fragments. It is generally used in experimental biology whenever RNA and DNA and their enzymes are to function in vitro, since Mg²⁺ is a necessary associate ion for nucleotides in biology, such as ATP.

It is used in several medical and topical (skin related) applications. It has been used in pills as supplemental sources of magnesium where it serves as a soluble compound which is not as laxitive as magnesium sulfate, and more bioavailable than magnesium hydroxide and magnesium oxide, since it does not require stomach acid to produce soluble Mg²⁺ ion.

In order to remove the deficiency caused due to lack of nutrients and electrolytes in food, food fortification is one of the most convenient ways to provide the desired micronutrients to the body. Providing a safe, inexpensive fortified water beverage with a modest amount of magnesium as magnesium chloride added is likely to be beneficial both in providing hydration and in improving magnesium intake. The proposed magnesium source for present invention is magnesium chloride, which is an ingredient with appropriate bioavailability, high solubility and clarity.

### Interest in Calcium Fortified Products

Along with the current developments of the overall functional food markets, the use of electrolytes especially calcium salts is expected to exhibit strong growth rates. Future trends include growing consumer concern regarding osteoporosis and bone health, leading to increased sales of calcium salts.

### Calcium Chloride (CaCl₂)

Calcium chloride is a white odorless inorganic salt that forms hydrates. It has hygroscopic and deliquescent properties and is readily dissociated into calcium and chloride ions in water. These physico-chemical properties indicate that calcium chloride released into the environment is distributed into the water compartment in the form of calcium and chloride ions. Its water solubility is 745 g/L at 20° C.

Both ions are essential constituents of the body of all animals. Calcium is essential for the formation of skeletons, neural transmission, muscle contraction, coagulation of the blood, and so on. Chloride is required for regulating intracellular osmotic pressure and buffering.

Providing a safe, inexpensive fortified water beverage with a modest amount of calcium added is likely to be beneficial both in providing hydration and in improving calcium intake.

### Functions of Potassium

Potassium is the third most abundant mineral in the body and is considered an electrolyte.
It plays many vital roles in human physiology, some of which are mentioned below.
It maintains fluid balance and reduces pain of arthritis
It is necessary for normal muscle contraction and helps in prevention of fatigue and depression.
It helps reduce the risk of stroke especially in people with high blood pressure.
It maintains intracellular osmotic pressure & transports carbon dioxide by being present in red cells.
Its ions help in prolong relaxation and inhibit cardiac contraction.

### How Much Magnesium is Required in Humans?

In 2004, the Food and Nutrition Board of the Institute of Medicine established an adequate intake level (AI) for potassium based on intake levels that have been found to lower blood pressure, reduce salt sensitivity, and minimize the risk of kidney stones.

TABLE 3
Adequate Intakes (AIs) for Potassium

| | Male | | | |
|---|---|---|---|---|
| Age | (mg) | Female (mg) | Pregnant (mg) | Lactating (mg) |
| 0-6 months | 400 | 400 | — | — |
| 7-12 months | 700 | 700 | — | — |
| 1-3 years | 3,000 | 3,000 | — | — |
| 4-8 years | 3,800 | 3,800 | — | — |
| 9-13 years | 4,500 | 4,500 | — | — |
| 14-18 years | 4,700 | 4,700 | 4700 | 5100 |
| 19-50 years | 4,700 | 4,700 | 4700 | 5100 |

### Dietary Sources of Potassium

Potassium is found in abundance in nuts, fruits, vinegar, paprika etc. bananas, broccoli, tomatoes, potatoes with skins, leafy green vegetables, oranges, dried fruits, dates, apricots, avocado, beans, peas, lentils & pea nuts are rich sources of potassium.

### Interest in Potassium Fortified Product

Deficiency of potassium causes Fatigue, Cramping legs, Muscle weakness, slow reflexes, Acne, Dry skin, Mood changes, Irregular heartbeat

### Potassium Bicarbonate

Potassium bicarbonate is a salt of potassium & bicarbonate ions & acts as a buffer to regulate acid base balance in the body or, in other words, it resist change in pH. According to US Food & Drug Administration (FDA), it is generally recognized as safe. It plays major role in human body such as
It reduces the acidity of dietary components such as proteins.
Decreases dental plaque acidity induced by sucrose and its buffering capacity is important to prevent dental cavities.
It also acts to regulate pH in the small intestine.
When ingested, example with mineral water, it helps buffer lactic acid generated during exercise, helps reduce muscular fatigue & dehydration in human body. Thus, drinking mineral water containing salt of bicarbonate may contribute to this beneficial intake.

Potassium is an essential dietary micronutrient and electrolyte. The term electrolyte refers to a substance that dissociates into ions (charged particles) in solution, making it capable of conducting electricity. Normal body function depends on tight regulation of potassium concentrations both inside and outside of cells. Potassium is essential for human and animal life. It is involved in many body functions such as proper heart functioning, proper muscle development and many more. Intake of electrolytes such as potassium bicarbonate tends to be low in Indian population. Thus, providing a safe, inexpensive fortified water beverage with a modest amount of potassium added is likely to be beneficial both in providing hydration and in improving potassium intake.

### Functions of Copper in Human Body

Copper plays a significant role in human physiology. Copper is utilized by most cells as a component of enzymes (cuproenzymes) essential for many biochemical functions to occur normally in human body. Copper is a major component of catalytic center with Zinc superoxide dismutase in different redox reactions in the enzymes and thus its presence is important for normal physiological functions.

Functions of cuproenzymes with oxidation-reduction activity and copper binding proteins in human are given in table 4.

TABLE 4
Function of cuproenzymes in oxidation and
reduction activity of human

| Cuproenzymes | Important functions |
|---|---|
| Amino acid oxidase | Amino acid metabolism i.e. |
| | Deamination of primary amines |
| Ceruloplasmin | Copper transport, conversion |
| | of iron into active form for |
| | transportation to various tissues. |
| Cytochrome-C oxidase | Energy production |
| Catechol oxidase | Synthesis of melanin |
| Dopamine-β monooxygenase | Noradrenaline synthesis |
| Protein-lysine 6-oxidase | Collagen and elastin cross-linking |
| Peptidylglycine monooxygenase | α-Amidation of neuropeptides |
| Superoxide dismutase | Protection of cell from free redical |
| | damage |
| Superoxide dismutase & | Strengthens connective tissues |
| lysyl oxidase | |
| Metallothionein | Radical scavenging, Metal transport |

Thus, vital role played by copper in the human body includes the following.

1. Formation of strong, flexible connective tissue and helps in the proper cross linking of collagen and elastin. Elastin helps to promote normal cardiovascular functions.

2. Production of collagen—the protein responsible for the structural formation of bone, cartilage, skin & tendon: prevents bone problems such as arthritis, osteoporosis, and rheumatoid arthritis.

3. Inhibition of free radical formation.

4. Formation of adenosine triphosphate (ATP) the fuel to run the body.

5. Production of hemoglobin thus helping to prevent anemia.

6. Promotes the maintenance of good skin health and contributes to healthy respiration and general strength.

7. Contributes to healthy and normal cholesterol levels.

8. Excellent for immune system.

### How Much Copper Do is Required in Humans?

The average adult human body generally contains 50-80 mg of copper. Recommended dietary allowance (RDA) for copper is shown in Table 4 as per The Food and Nutrition Board, Institute of Medicine, National Academies.

TABLE 5
Recommended dietary allowance (RDA) of copper for human

Copper, μg/day

| | | |
|---|---|---|
| Life stage | Male | Female |

Infants

| | | | |
|---|---|---|---|
| 0-6 | months | 200* | 200* |
| 7-12 | months | 220* | 220* |

Children

| | | | |
|---|---|---|---|
| 1-3 | years | 340 | 340 |
| 4-8 | years | 440 | 440 |
| 9-13 | years | 700 | 700 |
| 14-18 | years | 890 | 890 |

Adults

| | | | |
|---|---|---|---|
| 19-30 | years | 900 | 900 |
| 31-50 | years | 900 | 900 |
| 51-70 | years | 900 | 900 |
| >70 | years | 900 | 900 |

Pregnancy

| | | | |
|---|---|---|---|
| 14-18 | years | — | 1000 |
| 19-30 | years | — | 1000 |
| 31-50 | years | — | 1000 |

Lactating

| | | | |
|---|---|---|---|
| 14-18 | years | — | 1300 |
| 19-30 | years | — | 1300 |
| 31-50 | years | — | 1300 |

*is the Adequate Intakes and the rest are the Recommended Dietary Intakes as per given by FNB

Copper can be quite toxic when introduced into a living system in amounts that exceed the system's ability to render the metal safe through binding proteins or other means.

### Dietary Sources of Copper

Copper is found in number of food items, originating from both plants as well as animals. The plants or the plant parts normally rich in copper are nuts, seeds, whole grains, legumes, chocolates, cherries, dried nuts, root vegetables, cereals, peas, beans, tomatoes, milk, tea, potatoes while the food originating from animal source rich in copper are such as organ meat, chicken, seafood etc. Drinking water delivered through copper plumbing is a minor source of copper. It has long been established since the ancient times and the times of Ayurveda that drinking water when kept and taken from copper vessels is a cure for several ailments. For the same reason copper pipes were used for plumbing for delivering drinking water in many Middle East countries.

### Interest in Copper Fortified Product

Deficiency of copper causes
Anemia
Nutropenia
Bone abnormalities in low birth weight in infants & in young children; fractures, osteoporosis, epiphyscal separation, fraying and cupping of metaphyses with spur formation and subperiostal new bone formation.

### Copper Ion Source

Copper in the cupric (Cu²⁺) state is believed to be readily absorbable and efficiently transported across cellular membranes. The ions also provide a unique product stabilizing residual anti microbial efficacy for beverages that, retards the growth of bacteria & other microorganisms including Salmonella, Fungi, Coliforms, Vibriocholera. This unique efficacy is residual and occurs during the growth of the microorganisms.

The amount of copper proposed for this product is modest 0.1 mg per 100 ml of water. The proposed copper for source for this product is Copper sulphate, which appears to be an ingredient with appropriate bioavailability, solubility and neutral taste.

Copper in the cupric (Cu²⁺) state is believed to be readily absorbable and efficiently transported across cellular membranes. The ions also provide a unique product stabilizing residual anti microbial efficacy for beverages that retards the growth of bacteria & other microorganisms including Salmonella, Fungi, Coliforms, Vibriocholera. This unique efficacy is residual and occurs during the growth of the microorganisms.

Therefore, in order to prevent and bring down the occurrence of its deficiency diseases, it is necessary to supplement the daily food by providing additional quantities of the nutrients and this can be best done by way of fortification of a product of major consumption.

The present invention provides a composition to supplement electrolyte for recharging the human. The invention provides—electrolytes composition for fortifying food products. Said composition comprises:
Calcium Chloride;
Magnesium Chloride;
Potassium Bicarbonate;
Citric Acid acidity regulator (303);
Copper Ion Source; and
Potassium sorbate class II preservative (202)

The amount of the ingredients in the composition is as follows:
Calcium Chloride, at least 9.76% by wt;
Magnesium Chloride, at least 2.29% by wt;
Potassium Bicarbonate, at least 10.69% by wt;
Acidity regulator (330), at least 22.65% by wt;
Copper Ion Source, at least 54.70% by wt; and
Class II preservative (202) 0.01% by wt.

The composition of the present invention can be used as nutrient supplement in food items such as beverages, snacks, powered milk, etc. depending upon the nutrient requirement the composition of the present invention can be added in the food items,

In another embodiment the present invention provides a hydration supplement for human consumption. Said hydration supplement comprising the electrolyte composition along with suitable food item. The amount of composition in the hydrating supplement is 0.0039% by wt to 0.0069% by wt such that the amount of the calcium chloride is at least 0.00038% by weight or 3.8 mg/liter, amount of Magnesium chloride is at least 0.00009% by weight or 0.9 mg/liter, amount of potassium bicarbonate is at least 0.00042% by weight or 4.2 mg/liter and amount of Copper sulfate is at least 0.00215% by weight or 22 mg per liter.

Said hydration supplement is in liquid or semi solid form. Further said hydration supplement may be a beverage such as aerated drink, treated water, etc.

The invention further provides treated water fortified with electrolyte composition for use as beverages.

In yet another embodiment, the invention provides a treated water beverage comprising:
treated water prepared by the process of our co-pending patent application no. 1069/KOL/2010,
electrolyte composition comprising Calcium Chloride, Magnesium Chloride, Potassium Bicarbonate, Citric Acid acidity regulator (303), Copper Ion Source, potassium sorbate class II preservative (202).

The chemicals used in the water neutral beverage are selected in a manner as to be compatible with water such that they do not have any odour, the composition does not precipitate or reacts or sediments. Also, the shelf life of the elements has been so maintained in the composition that when the composition does not degrade when used with water. Said effects are the result of the synergistic effect among the ingredients of the composition.

Said beverage can be used for enhancing the well-being of the Indian consumer by maintaining the balance of body fluids. This provides a safe, inexpensive packaged drinking water like beverage with modest levels of micro-nutrients, beneficial in improving the health status of those suffering from loss of body fluids due to sweating or exertion.

Said treated water beverage with the ‘Recharge composition’ comprises essential electrolytes, Calcium Chloride (at least 3.8 mg per litre), Magnesium Chloride (at least 0.9 mg per litre), Potassium Bicarbonate (at least 4.2 mg per litre) and copper ion source (at least 21.5 mg per litre), Potassium Sorbate (0.01% by weight) of the fortified ‘Recharge’ hydration supplement.

In another embodiment the invention provides the process for the preparation of the treated water beverage fortified with electrolyte. Said process comprises the steps of:
preparing the treated water in accordance with the process taught isn our co-pending patent application,
adding proprietary composition in a suitable manner to get the beverage ready to fill and pack as required.

Said process involves effective treatment and sterilization of water without having to use chemicals or long storage. This treatment of source water involves filteration, ozonization, deozonization before filtration through reverse osmosis. The permeate is UV sterilized and then used as a solvent for the composition. This on line treatment reduces the risks of the water and also provides a consistent base characteristic on which the composition can enhance to achieve the desired nutritional characteristics. The beverage is filled and packed as required.

The limitation or disadvantage of this blend in terms of its restricted use to
(i) Food products only as a means of supplementation.

The limitation or disadvantage of this product relates to
(i) Form of ingestion, by drinking only.

The invention will now be explained with the help of following examples. However, the scope of the invention should not be limited to these examples as the person skilled in the art can easily vary the proportion of the ingredients and combinations.

### Example 1

### Preparation of the Electrolyte Fortifying Composition for Recharge

Two different packages (one dry parts & one Liquid part) is prepared for the batch of 25000 liters.

### 0.446 kg of Dry Part Comprises

0.095 kg of Calcium Chloride
0.025 kg of Magnesium Chloride
0.105 kg of Potassium bicarbonate
0.001 kg of potassium Sorbate
0.2225 kg of Citric Acid.

These ingredients are carefully weighed, blended and packaged in a sterile & dry container for use at the manufacturing facility. The specification sheets are maintained and the dry part has to meet the specifications at the manufacturing location before these are used for the preparation of the concentrate.

### 0.5375 of Liquid Part Comprises

0.5375 kg of Copper Ion Source

The ingredient is carefully weighed and packaged in a sterile & dry container for use at the manufacturing facility. The specification sheets are maintained and the liquid part has to meet the specifications at the manufacturing location before these are used for the preparation of the concentrate.

### Example 2

### Preparation of the Electrolyte Fortified Water Beverage with Fortifying Composition for Recharge

A blending tank of 225 liters is taken for making the concentrate. 200 liters of treated water is made available in the blending tank. The dry part is added to the water in the blending tank. The stirring operations are carried out for 15 mins. The liquid part is added while the stirring is maintained. Treated Water is then added to make the the volume of concentrate in the tank to 225 liters. Dosing operation is then carried out to make the fortified Zinc product.

1. An electrolyte fortifying composition for recharge comprising:
calcium chloride;
magnesium chloride;
potassium bicarbonate;
acidity regulator (330);
copper Ion Source; and
class II preservative (202);
wherein
Calcium Chloride, at least 9.76% by wt;
Magnesium Chloride, at least 2.29% by wt;
Potassium Bicarbonate, at least 10.69% by wt;
Acidity regulator (330), at least 22.65% by wt;
Copper Ion Source 54.70%, at least by wt; and
Class II preservative (202) 0.01% by wt.

2. The electrolyte fortifying composition for recharge as claimed in claim 1, wherein acidity regulator is citric acid.

3. The electrolyte fortifying composition as claimed in claim 1, wherein the class II preservative (202) is potassium sorbate.

4. A hydration supplement comprising an electrolyte fortifying composition comprising
calcium chloride;
magnesium chloride;
potassium bicarbonate;
acidity regulator (330);
copper Ion Source; and
class Mill II preservative (202);
wherein
Calcium Chloride, at least 9.76% by wt;
Magnesium Chloride, at least 2.29% by wt;
Potassium Bicarbonate, at least 10.69% by wt;
Acidity regulator (330), at least 22.65% by wt;
Copper Ion Source 54.70%, at least by wt; and
Class II preservative (202) 0.01% by wt.;
wherein the electrolyte fortifying composition is present in an amount such that calcium chloride is in an amount of 0.00038% % by weight, Magnesium chloride is in an amount of 0.00009% by weight, potassium bicarbonate is in an amount of 0.00042% by weight and Copper sulfate is in an amount of 0.00215% by weight.

5. The hydration supplement as claimed in claim 4, wherein said supplement is liquid or semi solid selected from the group comprising of aerated drinks, treated water, juices, etc.

6. A water beverage, comprising treated water and electrolyte fortifying composition for recharge comprising:
calcium chloride;
magnesium chloride;
potassium bicarbonate;
acidity regulator (330);
copper Ion Source; and
class II preservative (202);
wherein
Calcium Chloride, at least 9.76% by wt;
Magnesium Chloride, at least 2.29% by wt;
Potassium Bicarbonate, at least 10.69% by wt;
Acidity regulator (330), at least 22.65% by wt;
Copper Ion Source 54.70%, at least by wt; and
Class II preservative (202) 0.01% by wt.;
wherein, said beverage comprises 3.8 mg per litre of Calcium Chloride, 0.9 mg per litre of Magnesium Chloride, 4.2 mg per litre of Potassium Bicarbonate, and 1 mg per litre of copper and 0.01% by weight of Potassium Sorbate.

7. The water beverage as claimed in claim 6, wherein said water beverage is neutral, colourless, odourless and requires no added flavor or sweeteners to mask ingredients.

8. A process of preparing the water beverage fortified with tri-valent chromium and boron fortifying composition for health comprising the steps of:
effective treatment and sterilization of source water;
fortifying said treated water with the electrolyte fortifying composition for recharge.

9. The hydration supplement of claim 4, wherein the acidity regulator is citric acid.

10. The hydration supplement of claim 4, wherein the class II preservative (202) is potassium sorbate.

11. The water beverage of claim 6, wherein the acidity regulator is citric acid.

12. The water beverage of claim 6, wherein the class II preservative (202) is potassium sorbate.
